(19) United States
(12) Patent Application Publication
(10) Pub. No.: US 2017/0104854 A1
(43) Pub. Date: Apr. 13, 2017

(54) Ring Case

(71) Applicant: DESIGN SKIN, Seoul (KR)

(72) Inventor: Chan Hong PARK, Seoul (KR)

(21) Appl. No.: 15/003,039

(22) Filed: Jan. 21, 2016

(30) Foreign Application Priority Data
Oct. 12, 2015 (KR) 10-2015-0142166

(51) Int. Cl. H04M 1/02; A45F 5/00; H04B 1/3888; A45C 11/00

(52) U.S. Cl. CPC H04M 1/0206; A45C 11/00; A45F 5/00; H04B 1/3888; A45C 2011/002; A45C 2200/15

(57) ABSTRACT

A ring case includes: a main body; an engaging groove formed in the main body; and a ring-engaging body for engaging the engaging groove, and the ring-engaging body includes: a base for engaging rotatably the engaging groove, and a ring member configured to rotate with the base and engaging the base through a hinge so as to engage rotatably with the base. The ring member is fixed vertically with respect to the base. The engaging groove has a form of hollow circular band, and the base is provided with an engaging portion along an exterior circumferential surface of the base, so that the engaging portion is installed in the engaging groove. Embossing portions are formed along an exterior circumferential surface of the base, and depressed portions are formed inside the main body, so that when the base rotates the embossing portions are received into or extracted from the depressed portions.

### FIELD OF TECHNOLOGY

The present invention relates to a ring case for receiving a mobile electronic device, and more specifically to a ring case, in which the a ring-engaging body is engaged rotatably to a case main body, so that a user inserts a finger to the ring member and uses the mobile electronic device safely.

### BACKGROUND OF INVENTION

In general, a recent mobile phone is put on the market as a smart phone that has various built-in functions. Various activities such as voice phone call, video watching, game, etc. are possible with the mobile phone. Such mobile phones become necessities to the general populace, and usually, they become very expensive personal items. The individual users use cases for the mobile phones in order to protect the expensive mobile phones from scratches and damages.

Conventional mobile phone cases are provided in many forms and kinds. In general, some are made of soft material such as a simple jelly type, and various kinds of phone cases exist including one with a luxurious design, characters, etc.

Such conventional phone cases can protect the phones from scratches and damages. However, even with such a phone case, it was still possible for the phone to slip off the hand of the user.

In general, the users use the mobile phone for an extended time period for talking over the phone, watching video, etc. In such cases, the mobile phones are dropped and then broken due to mistakes or external shock quite frequently. The users frequently rotate the mobile phone to a horizontal position for watching video or playing games, and in such cases it happens more frequently to drop the mobile phone.

When the mobile phone is slipped off and falls down, some internal parts of display of the mobile phone are broken, which cost a lot to repair. Also, it takes a long time for repairing, which is not an ignorable factor, either.

However, there is a problem that a separate device for preventing the mobile phone from being dropped has not been provided so far.

Such problems exist not only for the mobile phone case, but also for the other types of mobile electronic devices. Recently, the usage of tablet PC such as iPad®, Galaxy Tab®, etc. in addition to the mobile phone increases. The tablet PC may have a case for enclosing it and preventing scratches and damages, but it is a problem that there is no separate device for preventing the tablet PC from being slipped off from the user hand and falling down. In the case of tablet PC, it is much bigger than the mobile phone, and therefore such problems may be more serious.

In order to use the mobile phone or the tablet PC for an extended time period, a rack for mobile phone may be provided to use them. However, since the mobile phone rack must be purchased separately from the mobile phone case, it burdens the user in cost and in carrying around it separately.

### DISCLOSURE OF INVENTION

### Problems to Solve

The invention is for solving the problems mentioned in the above, more specifically it relates to providing a ring case, in which the ring-engaging body portion engages the case main body portion rotatably so that the user inserts his/her finger to a ring member so as to prevent the mobile electronic device from being slipped off from the user hand, enabling to use the mobile electronic device safely.

### Solutions to Problems

A ring case includes: a main body; an engaging groove formed in the main body; and a ring-engaging body for engaging the engaging groove, and the ring-engaging body includes: a base for engaging rotatably the engaging groove, and a ring member configured to rotate with the base and engaging the base through a hinge so as to engage rotatably with the base.

Preferably, the ring member is fixed vertically with respect to the base.

Preferably, the engaging groove has a form of hollow circular band, and the base is provided with an engaging portion along an exterior circumferential surface of the base, so that the engaging portion is installed in the engaging groove.

Preferably, embossing portions are formed along an exterior circumferential surface of the base, and depressed portions are formed inside the main body, so that when the base rotates the embossing portions are received into or extracted from the depressed portions.

Preferably, a top portion and a bottom portion of a rear surface of the main body portion protrude with respect to a central portion of the rear surface of the main body portion.

### Effects of Invention

The ring case according to the invention has advantages that by having the ring-engaging body portion engage the case main body portion rotatably the user inserts his/her finger to a ring member so as to prevent the mobile electronic device from being slipped off from the user hand, enabling to use the mobile electronic device safely.

Also, the ring case according to the invention has advantages that it can work as a stand rack by propping up the ring member on the base and then putting up the ring member on the floor.

### BRIEF DESCRIPTION OF DRAWINGS

FIG. 1 is a side view and a front view of a ring case according to an embodiment of the invention.

FIG. 2 is a cross-sectional view along the line A-A in FIG. 1.

FIG. 3 is a cross-sectional view along the line B-B in FIG. 1.

FIG. 4 is a diagram showing a ring-engaging body portion according to an embodiment of the invention.

FIG. 5 is a diagram showing depressed portions formed in the main body portion according to of the invention.

FIG. 6 is a diagram showing a top portion and a bottom portion of the rear surface of the main body portion protruding above a central portion of the rear surface of the main body portion.

FIG. 7 is a diagram showing a ring case according to an embodiment of the invention used as a stand rack.

FIG. 8 is a diagram showing a ring member of the ring case according to an embodiment of the invention.

FIG. 9 is a diagram showing an engaging portion and an engaging groove according to an embodiment of the invention.

### DETAILED DESCRIPTION OF INVENTION

Below, referring to the drawings, preferable embodiments of the invention are described in detail. The attached drawings show a mobile phone case according to an embodiment of the invention, but, of course, the present invention can be applied to other mobile electronic devices such as iPad®, Galaxy Tab®, etc.

The invention relates to providing a ring case (100), in which the ring-engaging body portion (130) engages the case main body portion (110) rotatably so that the user inserts his/her finger to a ring member (150) so as to prevent the mobile electronic device from being slipped off from the user hand, enabling to use the mobile electronic device safely.

A ring case (100) of the invention includes a main body portion (110), a engaging groove (120), and a ring-engaging body portion (130). In the main body portion (110) is formed the engaging groove (120), and to the engaging groove (120) is engaged the ring-engaging body portion (130). The ring-engaging body portion (130) can rotate with the base (140) engaged rotatably to the engaging groove (120), and a ring member (150) that can rotate with the base (140) and one side engages the base (140) through a hinge (151).

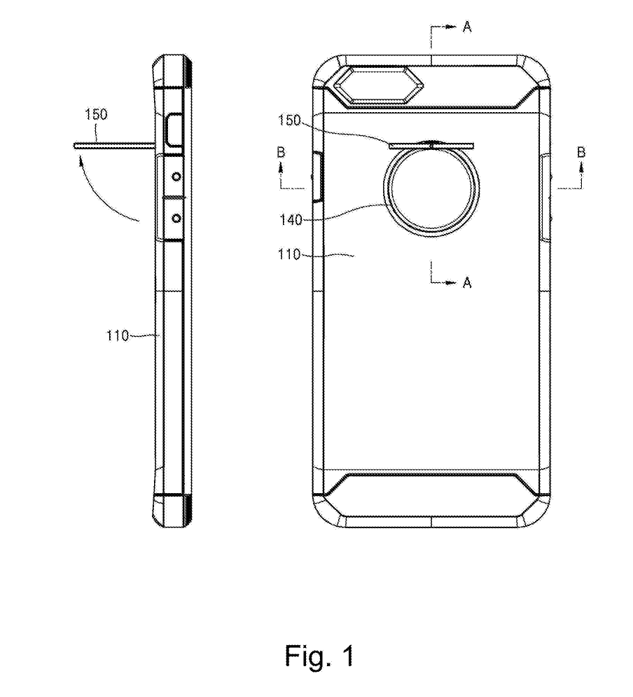

Referring to FIG. 1, the main body portion (110) includes a receiving portion (111) for receiving a mobile electronic device and a protecting portion (112) engaging a rear surface of the receiving portion (111). The material of the receiving portion (111) may be polyurethane, and more specifically thermoplastic polyurethane (TPU). The protecting portion (112) may be formed with polycarbonate. The receiving portion (111) and the protecting portion (112) can be formed integrally. Also, the receiving portion (111) and the protecting portion (112) can be formed integrally with a same material.

In the main body portion (110) can be provided a circular hole penetrating from the rear surface to the front surface of the main body portion (110). The circular hole may not penetrate through the main body portion (110), but can be formed in the protecting portion (112).

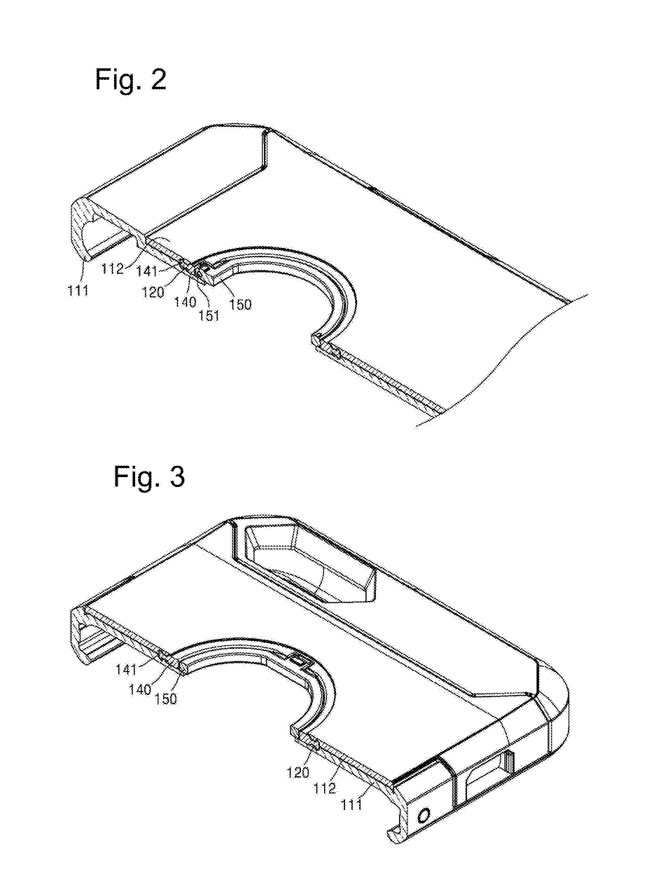

Referring to FIGS. 2 and 3, the engaging groove (120) is formed in the main body portion (110). More specifically, the engaging groove (120) is formed in the main body portion (110) along the perimeter of the circular hole, and between the receiving portion (111) and the protecting portion (112). That is, the engaging groove (120) is formed in a space formed between the receiving portion (111) and the protecting portion (112). An interval is provided in the space between the receiving portion (111) and the protecting portion (112). The interval is formed so that an interval formed in the main body portion (110) is longer than an interval formed around the circular hole. Therefore, the shape of the engaging groove (120) has a larger space in the 110 than a space around the circular hole. (That is, the space in the engaging groove (120) is formed large, and the entrance to the engaging groove (120) is formed small.)

The engaging groove (120) forms empty space consecutively around the circular hole between the receiving portion (111) and the protecting portion (112), and may be formed with a shape of circular band having hollow inside.

The engaging groove (120) is not limited to be formed between the receiving portion (111) and the protecting portion (112), but can be formed in various shapes in the main body portion (110). For example, the main body portion (110) is formed between the receiving portion (111) and the protecting portion (112) integrally with a single material, and the engaging groove (120) can be formed in the main body portion (110) that is formed with a single material. Also, the engaging groove (120) may be formed in the receiving portion (111) only, or in the protecting portion (112) only. Besides, if the base (140) engages the main body portion (110), the engaging groove (120) can be formed in various locations.

The ring-engaging body portion (130) engages to the engaging groove (120). More specifically, the ring-engaging body portion (130) includes the base (140) and the ring member (150). The base (140) is inserted rotatably to the engaging groove (120). In the base (140) are provided the engaging portion (141) protruding along the outer circumferential surface of the base (140). The engaging portion (141) are installed on the engaging groove (120).

The shape of the engaging portion (141) may be formed correspondingly to the shape of the engaging groove (120). The engaging groove (120) in formed so as to have a large internal space and a narrow entrance. Thus, the engaging portion (141) is formed so that a thickness at an end portion of the engaging portion (141) is larger than a thickness of a portion where the engaging portion (141) begins to protrude from the base (140). The end portion of the engaging portion (141) is installed in the engaging groove (120). Since the entrance of the engaging groove (120) is narrower than the internal space of the engaging groove (120), the engaging portion (141) can be prevented from dislocating from the engaging groove (120).

The engaging portion (141) is installed rotatably along the engaging groove (120). The base (140) can rotates with respect to the engaging groove (120) while the engaging portion (141) moves along the inside of the engaging groove (120) having a shape of circular band. If using lubricant between the engaging groove (120) and the engaging portion (141), the base (140) can rotate more smoothly with respect to the engaging groove (120).

The engaging portion (141) may be formed consecutively along the outer circumferential surface of the base (140), and may be formed along just a portion of the outer circumferential surface of the base (140). In a case that the engaging portion (141) is formed along just a portion of the outer circumferential surface of the base (140), the engaging portion (141) may be formed in plural numbers.

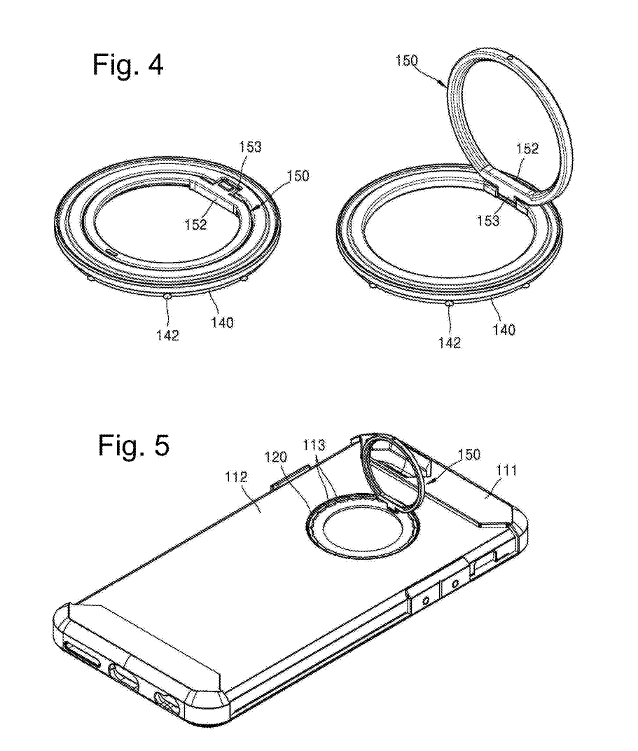

Referring to FIG. 4, in the base (140) are formed embossing portions (142) protruding along the outer circumferential surface of the base (140). FIG. 5 shows how the depressed portions are formed in the main body portion (110) by removing the base (140). Referring to FIG. 5, in the main body portion (110) are formed the depressed portions (113) which the embossing portions (142) are received to or come out from when the base (140) rotates. More specifically, when the base (140) rotates, the embossing portions (142) are latched to the depressed portions (113), stopping the rotation of the base (140). In order to keep rotating of the base (140), a force is applied to the base (140). If the force is applied to the base (140), the embossing portions (142) escape from the depressed portions (113), rotate up to the position where the depressed portions (113) are disposed and then stop rotating. By this, the base (140) can be rotated by a specific angle.

In order for the embossing portions (142) to be received to and escape from the depressed portions (113), preferably the depressed portions (113) may be formed with an elastic material. If the force is applied to the embossing portions (142) after the embossing portions (142) are received in the depressed portions (113), an elastic deformation occurs in the embossing portions (142) and the embossing portions (142) escape. The embossing portions (142) may be formed with a material having a specific strength, so that an appropriate elastic deformation occurs when the force is applied to the embossing portions (142). Preferably the embossing portions (142) is formed with aluminum, and the depressed portions (113) is made of polyurethane.

Since the depressed portions (113) are formed with polyurethane preferably, the depressed portions (113) may be formed on the receiving portion (111) formed with polyurethane in the main body portion (110).

The depressed portions (113) and the embossing portions (142) may be formed plurally as well as singularly. The intervals between the plurality of depressed portions (113) and the plurality of embossing portions (142) may be even or not.

The ring member (150) is rotatable with the base (140), and one side engages the base (140) through the hinge (151), engaging the base (140) rotatably. The ring member (150) may be rotatable in many angles with respect to the base (140), and may be raised and held vertically with respect to the base (140).

In order to raise vertically and hold the ring member (150) with respect to the base (140), the ring member (150) may be formed in a following shape. The ring member (150) is formed in a ring shape, and a linear portion (152) is provided on one side. That is, it has a shape that a portion of the ring shape is cut off and the cut-off portion is connected with a linear portion. In the linear portion (152) is provided a protruding portion (153) protruding from the linear portion (152) by a specific height, and in the protruding portion (153) is provided a hole to which the hinge (151) can be inserted. If inserting the hinge (151) through the hole provided in the protruding portion (153) and engaging the hinge (151) to the base (140), the ring member (150) can rotate with respect to the base (140).

On the internal surface of the base (140) may be provided a groove along the shape of the protruding portion (153), so that the protruding portion (153) is inserted. Also, the groove formed on the internal surface of the base (140) may be extended up to an external side surface of the base (140). That is, the base (140) may be penetrated from the internal surface to the external surface so as to have a cut-off shape, and into the cut-off portion can be inserted the protruding portion (153). The protruding portion (153) may protrude vertically from the linear portion (152), or obliquely from the linear portion (152). The groove formed in the base (140) may be formed correspondingly to such a shape of the protruding portion (153).

Referring to FIG. 4, the top surface of the base (140) is formed flat. Thus, if raising the ring member (150) vertically on the base (140), the linear portion (152) latches to the base (140) and be raised to above the top surface of the base (140). Accordingly, the ring member (150) does not rotate further beyond a vertical position and is held vertically. However, the angle by which the ring member (150) rotates is not limited to vertical, and if necessary it can rotate in various angles. For example, if forming the top surface of the base (140) contacting with the linear portion (152) obliquely, the angle by which the ring member (150) rotates and is held can be controlled.

In order to facilitate the rotation of the ring member (150) with respect to the base (140), the portion between the top surface and the side surface of the linear portion (152) can be formed round, and a gap may be formed between a side surface of the linear portion (152) and a side surface of the base (140). The material of the base (140) and the ring member (150) may be aluminum preferably.

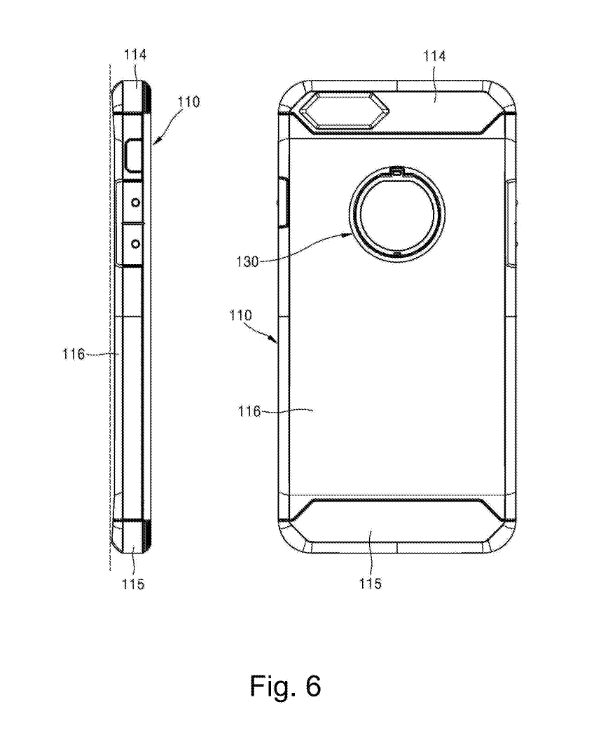

Referring to FIG. 6, the top portion (114) and the bottom portion (115) of the rear surface of the main body portion (110) may be formed so as to protrude with respect to the central portion (116) of the rear surface of the main body portion (110). More specifically, the thickness of the central portion (116) of the main body portion (110) is formed thinner than the thickness of the top portion (114) and the bottom portion (115) of the main body portion (110). The top portion (114) and the bottom portion (115) of the rear surface of the main body portion (110) are formed with polyurethane, and the central portion (116) of the rear surface of the main body portion (110) is formed with polycarbonate. Such a shape may be formed by extending the receiving portion (111) of the main body portion (110) up to the top portion (114) and the bottom portion (115) of the rear surface of the main body portion (110) and forming the central portion (116) of the rear surface of the main body portion (110) with the protecting portion (112) of the main body portion (110).

The base (140) and the ring member (150) forming the ring-engaging body portion (130) may have a thickness so as not to protrude above the rear surface of the main body portion (110) preferably. That is, in the circular hole formed in the main body portion (110) is formed the ring-engaging body portion (130), so that the rear surface of the main body portion (110) is flat preferably. If the ring-engaging body portion (130) protrude above the rear surface of the main body portion (110) the outlook is not good, because due to the protruding portion of the ring-engaging body portion (130) the user may be uncomfortable.

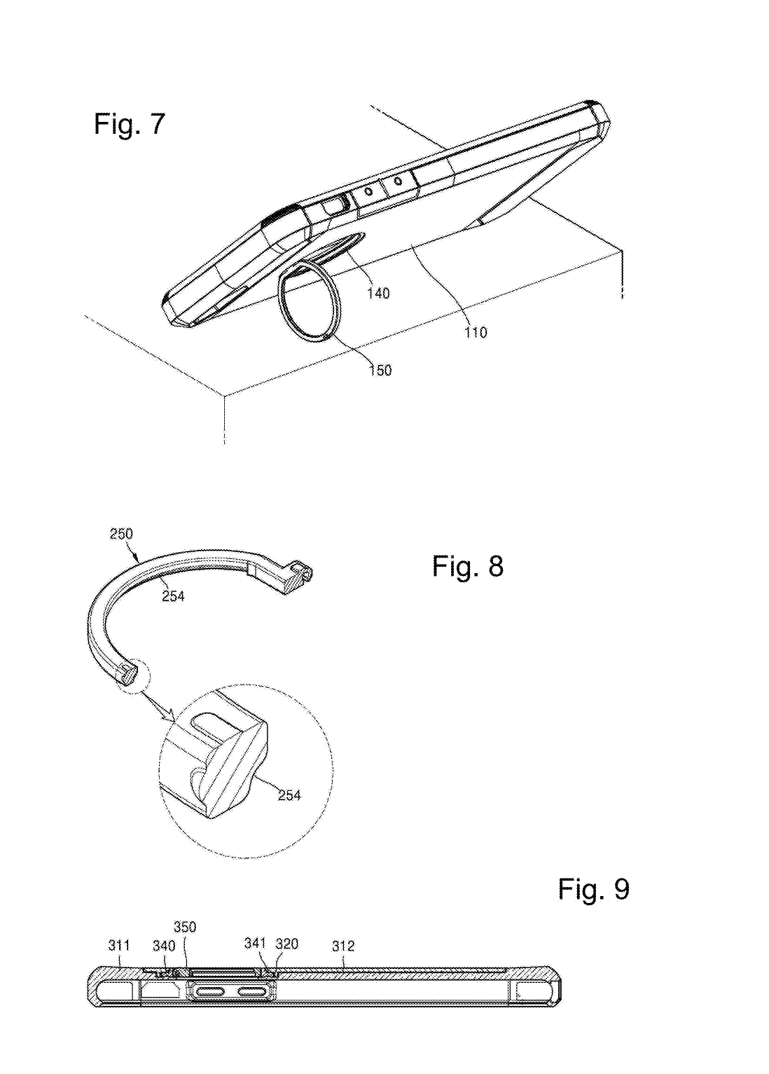

Referring to FIG. 7, the ring case (100) may be used as a stand rack using the ring member (150). The ring member (150) may be raised and held with respect to the base (140). If putting up the ring member (150) on the ground or floor after raising and holding the ring member (150), the ring case (100) can used as a stand rack.

The rotation of the ring-engaging body portion (130) can be done as follows. If a force is applied in a direction where the ring-engaging body portion (130) rotates, the engaging portion (141) installed in the engaging groove (120) moves in the engaging groove (120), the ring-engaging body portion (130) can rotate. If the embossing portions (142) protruding along the outer circumferential surface of the base (140) are latched at the depressed portions (113) formed in the main body portion (110) while rotating, it stops rotating. If the force is applied to the ring-engaging body portion (130) again, the embossing portions (142) escape the depressed portions (113), and then rotate to the position where the depressed portions (113) are disposed.

The effects of the ring case (100) described in the above are as follows.

First, the ring member (150) is raised and the user inserts his or her finger to the ring member (150) to use the mobile electronic device. By doing that, the mobile electronic device can be prevented from being slipped off from the hand or dropping the mobile electronic device from external shock.

The base (140) and the ring member (150) forming the ring-engaging body portion (130) can be rotated. Thus the user can rotate the ring member (150) in various angles to use. For example, in a case of using the mobile electronic device horizontally, the user can rotate the ring member (150) so as to insert the finger easily.

The ring member (150) can be used as a stand rack as described in the above. If putting up the ring member (150) on the ground after raising and holding the ring member (150), it becomes a stand rack. Since the ring member (150) is rotatable, the ring member (150) can be used to put up the mobile electronic device in various degrees when using the ring member (150) as a stand.

The top portion (114) and the bottom portion (115) of the rear surface of the main body portion (110) may protrude more with respect to the central portion (116) of the rear surface of the main body portion (110), and the top portion (114) and the bottom portion (115) of the main body portion (110) are made of polyurethane. In general, the camera of the mobile electronic device is disposed in a rear top portion of the mobile electronic device. Therefore, if making the top portion of the rear surface of the main body portion (110) with polyurethane and protruding, the camera can be protected more efficiently. Also, the central portion (116) of the rear surface of the main body portion (110) may be formed with polycarbonate, and polycarbonate is a material that is prone to be scratched. However, by protruding the top portion (114) and the bottom portion (115) of the rear surface of the main body portion (110) with respect to the central portion (116) of the real surface of the main body portion (110), the central portion (116) of the rear surface of the main body portion (110) can be prevented from being scratched. (Polyurethane is resistant to scratches.) Besides, the thickness of the central portion (116) of the rear surface of the main body portion (110) is smaller than the thickness of the top portion (114) and and the bottom portion (115) of the rear surface of the main body portion (110), enhancing the grip feeling of the user.

The ring case (100) of the invention described in the above can be changed as follows.

The structure installing the base (140) in the engaging groove (120) can be done with various structures as long as the base (140) engages the engaging groove (120) rotatably. For example, the outer diameter of the base (140) can be made larger than diameter of the circular hole and then the base (140) can be inserted between the main body portion (110). By this, the base (140) can be prevented from dislocating from the main body portion (110) and can be engaged rotatably. Here, the engaging portion (141) protruding on the outer circumferential surface of the base (140) may be gotten rid of. Also, in such a case the engaging portion (141) may be removed and not used, and the embossing portions (142) formed on the outer circumferential surface of the base (140) and the depressed portions (113) formed in the main body portion (110) may be used.

Referring to FIG. 8, on the inner surface of the ring member (250) is provided a latching step (254) which the user can grab. More specifically, the cross-section of the ring member (250) is formed so that the width of the top portion is larger than that of the bottom portion, and a step is formed between the top portion and the bottom portion. If the user inserts a finger to the bottom portion of the ring member (250), due to the step difference between the top and bottom portions, the user's finger is latched in the top portion of the ring member (250). Through that, the ring member (250) can be raised easily.

The engaging groove and the engaging portion provided on the outer circumferential surface of the base of the invention can be achieved in various shapes as long as the engaging portion is not dislocated from the engaging groove. Referring to FIG. 9, the engaging portion (341) protrudes along the outer circumferential surface in the lower portion of the base (340), and the protruding portion is inserted and installed in the engaging groove (320). The engaging groove (320) may be formed accordingly to the shape of the engaging portion (341), and the engaging groove (320) may be formed between the receiving portion (311) and the protecting portion (312).

Another embodiment of the invention may provide a magnet in the base, and the ring member may include magnetic material to which the magnet is attracted. By this, when putting down the ring member after using it, the ring member can be put down easily due to the magnet. The position of the magnet provided in the base may be the inside of the base, or the surface of the base. Besides, the magnet can be disposed in various locations of the base. The magnetic material in the ring member may be inside the ring member, or on the outer portion of the ring member.

Various embodiments of the invention have been described in the above, but they are not limiting, and as long as they can be deduced reasonably from the claims of the invention, any variations to them belong to the scope of right of the present invention.

The ring case (100) of the invention may be formed by including the main body portion (110), the main body portion (110), the engaging groove (120), and the ring-engaging body portion (130) including the base (140) and the ring member (150), and some other components may be omitted.

[Reference Numerals]

| | | | |
|---|---|---|---|
| 100 | ring case | 110 | main body portion |
| 111 | receiving portion | 112 | protecting portion |
| 113 | depressed portions | 123 | engaging groove |
| 130 | ring-engaging body portion | 140 | base |
| 141 | engaging portion | 142 | embossing portions |
| 150 | ring member | 151 | hinge |
| 254 | latching step | | |

What is claimed is:

1. A ring case for receiving a mobile electronic device, the ring case comprising:
a main body portion;
an engaging groove formed in the main body portion; and
a ring-engaging body portion configured to engage the engaging groove,
wherein the ring-engaging body portion comprises:
a base configured to engage rotatably the engaging groove, and
a ring member configured to rotate with the base and engaging the base through a hinge so as to engage rotatably with the base.

2. The ring case of claim 1, wherein the ring member is fixed vertically with respect to the base.

3. The ring case of claim 1, wherein the engaging groove has a form of hollow circular band, and the base is provided with an engaging portion along an exterior circumferential surface of the base, so that the engaging portion is installed in the engaging groove.

4. The ring case of claim 1, wherein a plurality of embossing portions are formed along an exterior circumferential surface of the base, and a plurality of depressed portions are formed inside the main body portion, so that when the base rotates the plurality of embossing portions are received into or extracted from the plurality of depressed portions.

5. The ring case of claim 1, wherein the base and the ring member are made of aluminum.

6. The ring case of claim 1, wherein the main body portion comprises a receiving portion for receiving the mobile electronic device and a protecting portion attached to a rear surface of the receiving portion, and wherein the receiving portion is made of polyurethane and the protecting portion is made of polycarbonate.

7. The ring case of claim 6, wherein the engaging groove is formed between the receiving portion and the protecting portion, and the ring-engaging body portion is engaged with the engaging groove.

8. The ring case of claim 1, wherein a top portion and a bottom portion of a rear surface of the main body portion protrude with respect to a central portion of the rear surface of the main body portion.

9. The ring case of claim 8, wherein the top and bottom portions of a rear surface of the main body portion are made of polyurethane.

10. The ring case of claim 1, wherein a latching step suitable for a user's grip is provided on an inner surface of the ring member.
